(19) United States
(12) Patent Application Publication
(10) Pub. No.: US 2025/0249479 A1
(43) Pub. Date: Aug. 7, 2025

(54) TRANSDUCER

(71) Applicant: InnoLux Corporation, Miao-Li County (TW)

(72) Inventors: Yu-Tsung LIU, Miao-Li County (TW); Yu-Ting TSAI, Miao-Li County (TW); I-An YAO, Miao-Li County (TW)

(21) Appl. No.: 19/016,528

(22) Filed: Jan. 10, 2025

(30) Foreign Application Priority Data
Feb. 7, 2024 (CN) 202410174588.6

(51) Int. Cl. B06B 1/02

(52) U.S. Cl. CPC B06B 1/02

(57) ABSTRACT

A transducer includes: a substrate; and a plurality of transducer elements disposed on the substrate, and each transducer element including: a bottom electrode; an oscillatory element disposed on the bottom electrode and having an opening, wherein there is a cavity between the bottom electrode and the oscillatory element; a top electrode disposed on the oscillatory element, wherein the top electrode and the bottom electrode are overlapped in a top view direction; and a passivation layer disposed on the oscillatory element and the top electrode and in the opening of the oscillatory element, wherein the passivation layer extends continuously from a position on the oscillatory element to a position on the bottom electrode through the opening and the cavity.

### CROSS-REFERENCE TO RELATED APPLICATIONS

This application claims the benefits of the Chinese Patent Application Serial Number 202410174588.6, filed on Feb. 7, 2024, the subject matter of which is incorporated herein by reference.

### BACKGROUND

### Field

The present disclosure relates to a transducer and, more specifically, to a transducer with an oscillatory element.

### Description of Related Art

A transducer, such as an ultrasonic transducer, can have functions such as measuring the distance of an object by emitting and receiving ultrasonic waves. It has been widely used in aerial photography, medical imaging, fingerprint recognition, ultrasonic microscopes and other fields.

However, transducers on the market still have shortcomings such as cumbersome preparation processes and poor device reliability.

Therefore, it is desirable to provide an improved transducer in order to improve the previous defects.

### SUMMARY

The present disclosure provides a transducer, comprising: a substrate; and a plurality of transducer elements disposed on the substrate, wherein each of the plurality of transducer elements comprises: a bottom electrode; an oscillatory element disposed on the bottom electrode and having an opening, wherein there is a cavity between the bottom electrode and the oscillatory element; a top electrode disposed on the oscillatory element, wherein the top electrode and the bottom electrode are overlapped in a top view direction; and a passivation layer disposed on the oscillatory element and the top electrode and in the opening of the oscillatory element, wherein the passivation layer continuously extends from a position on the oscillatory element to a position on the bottom electrode through the opening and the cavity.

The present disclosure further provides a transducer, comprising: a substrate; and a plurality of transducer elements disposed on the substrate, wherein each of the plurality of transducer elements comprises: a bottom electrode; an oscillatory element disposed on the bottom electrode and having an opening, wherein there is a cavity between the bottom electrode and the oscillatory element; a top electrode disposed on the oscillatory element, wherein the top electrode and the bottom electrode are overlapped in a top view direction; a sealing layer disposed on the oscillatory element and covering the opening; and a passivation layer disposed on the sealing layer, the oscillatory element and the top electrode.

Other novel features of the disclosure will become more apparent from the following detailed description when taken in conjunction with the accompanying drawings.

### BRIEF DESCRIPTION OF DRAWINGS

FIG. 1A is a schematic view of a transducer according to one embodiment of the present disclosure.

FIG. 1B is a top schematic view of a transducer element according to one embodiment of the present disclosure.

FIG. 1C is a cross-sectional schematic view along the line A-A′ in FIG. 1B.

FIG. 2 is a cross-sectional schematic view of a transducer element according to one embodiment of the present disclosure.

FIG. 3 is a cross-sectional schematic view of a transducer element according to one embodiment of the present disclosure.

FIG. 4 is a cross-sectional schematic view of a transducer element according to one embodiment of the present disclosure.

FIG. 5 is a cross-sectional schematic view of a transducer element according to one embodiment of the present disclosure.

FIG. 6A is a schematic view of a transducer according to one embodiment of the present disclosure.

FIG. 6B is a schematic view of an equivalent circuit of the transducer shown in FIG. 6A.

FIG. 6C is a cross-sectional schematic view of the transducer shown in FIG. 6A.

FIG. 7A is a schematic view of a transducer according to one embodiment of the present disclosure.

FIG. 7B is a schematic view of an equivalent circuit of the transducer shown in FIG. 7A.

FIG. 7C is a cross-sectional schematic view of the transducer shown in FIG. 7A.

### DETAILED DESCRIPTION

The following is specific embodiments to illustrate the implementation of the present disclosure. Those who are familiar with this technique can easily understand the other advantages and effects of the present disclosure from the content disclosed in the present specification. The present disclosure can also be implemented or applied by other different specific embodiments, and various details in the present specification can also be modified and changed according to different viewpoints and applications without departing from the spirit of the present disclosure.

It should be noted that, in the present specification, when a component is described to have an element, it means that the component may have one or more of the elements, and it does not mean that the component has only one of the element, except otherwise specified. Furthermore, the ordinals recited in the specification and the claims such as “first”, “second” and so on are intended only to describe the elements claimed and imply or represent neither that the claimed elements have any proceeding ordinals, nor that sequence between one claimed element and another claimed element or between steps of a manufacturing method. The use of these ordinals is merely to differentiate one claimed element having a certain designation from another claimed element having the same designation.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

The terms, such as “about”, “substantially”, or “approximately”, are generally interpreted as within 10%, 5%, 3%, 2%, 1%, or 0.5% of a given value or range. The quantity given here is an approximate quantity, that is, without specifying “about”, “approximately”, “substantially” and “approximately”, “about”, “approximately”, “substantially” and “approximately” can still be implied. Furthermore, when a value is “in a range from a first value to a second value” or “in a range between a first value and a second value”, the value can be the first value, the second value, or another value between the first value and the second value.

In the present specification, except otherwise specified, the terms (including technical and scientific terms) used herein have the meanings generally known by a person skilled in the art. It should be noted that, except otherwise specified, in the embodiments of the present disclosure, these terms (for example, the terms defined in the generally used dictionary) should have the meanings identical to those known in the art, the background of the present disclosure or the context of the present specification, and should not be read by an ideal or over-formal way.

In addition, relative terms such as “below” or “under” and “on”, “above” or “over” may be used in the embodiments to describe the relative relationship between one element and another element in the drawings. It will be understood that if the device in the drawing was turned upside down, elements described on the “lower” side would then become elements described on the “upper” side. When a unit (for example, a layer or a region) is referred to as being “on” another unit, it can be directly on the another unit or there may be other units therebetween. Furthermore, when a unit is said to be “directly on another unit”, there is no unit therebetween. Moreover, when a unit is said to be “on another unit”, the two have a top-down relationship in a top view, and the unit can be disposed above or below the another unit, and the top-bottom relationship depends on the orientation of the device.

In the present disclosure, any two values or directions used for comparison may have certain errors. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°.

It should be noted that the technical solutions provided in different embodiments below can be replaced, combined or mixed with each other to constitute another embodiment without violating the spirit of the present disclosure.

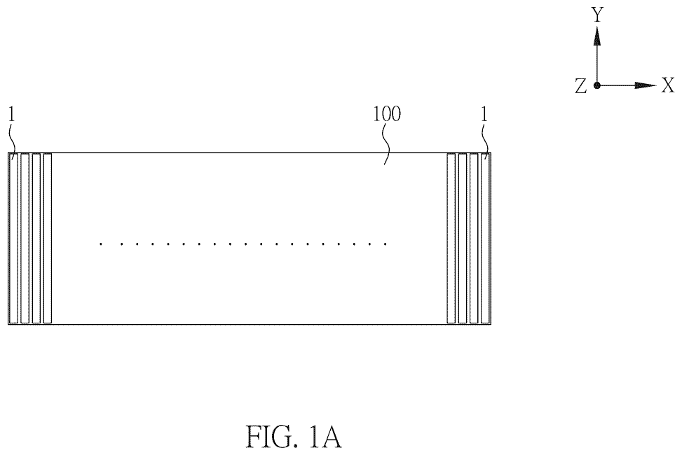

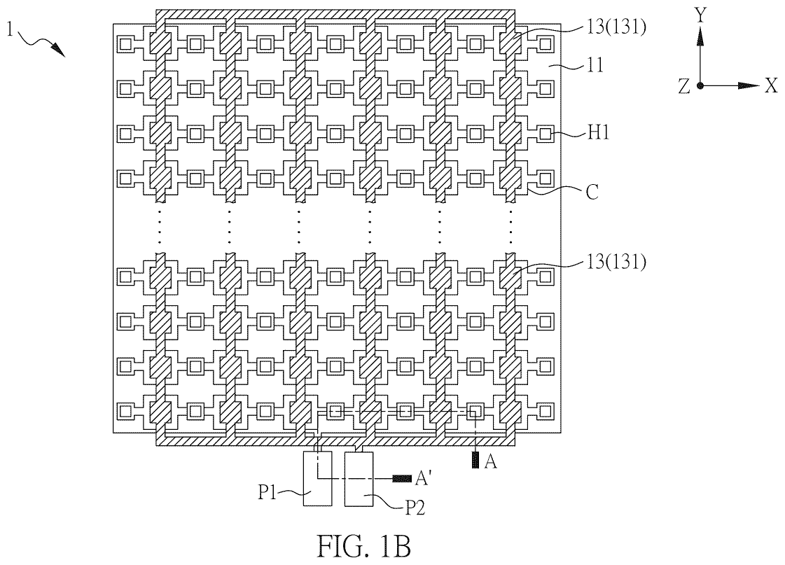

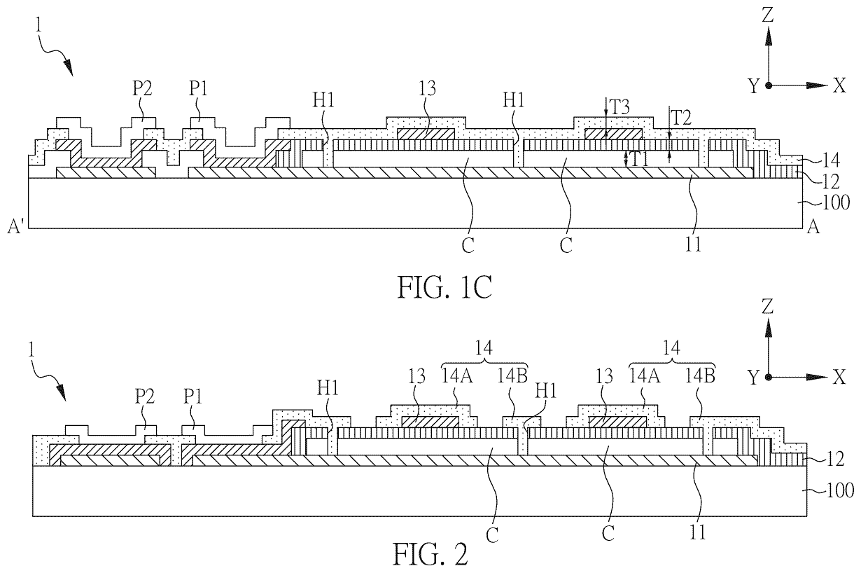

FIG. 1A is a schematic view of a transducer according to one embodiment of the present disclosure. FIG. 1B is a top schematic view of a transducer element according to one embodiment of the present disclosure. FIG. 1C is a cross-sectional schematic view along the line A-A′ in FIG. 1B. For convenience of explanation, some components are omitted in FIG. 1B.

In one embodiment of the present disclosure, as shown in FIG. 1A, a transducer may comprise: a substrate 100; and a plurality of transducer elements 1 disposed on the substrate 100. The transducer elements 1 may arrange on the substrate 100 along a direction (for example, the X direction) to for a one-dimensional (1D) transducer. In the present disclosure, the transducer may comprise, for example 64, 128 or more transducer elements 1, but the present disclosure is not limited thereto.

In one embodiment of the present disclosure, as shown in FIG. 1B and FIG. 1C, each transducer element 1 may comprise: a bottom electrode 11; an oscillatory element 12 disposed on the bottom electrode 11 and having an opening H1, wherein there is a cavity C between the bottom electrode 11 and the oscillatory element 12; a top electrode 13 disposed on the oscillatory element 12, wherein the top electrode 13 and the bottom electrode 11 are overlapped in the top view direction Z; and a passivation layer 14 disposed on the oscillatory element 12 and the top electrode 13 and in the opening H1 of the oscillatory element 12, wherein the passivation layer 14 continuously extends from a position on the oscillatory element 12 to a position on the bottom electrode 11 through the opening H1 and the cavity C. More specifically, the passivation layer 14 may cover the oscillatory element 12 and the top electrode 13 to improve the reliability of the transducer element 1. In addition, the opening H1 of the oscillatory element 12 may be connected to the cavity C, and the passivation layer 14 may fill the opening H1 of the oscillatory element 12 and extend from the opening H1 to the cavity C. A part of the passivation layer 14 (for example, the passivation layer 14 disposed in the opening H1) may be in contact with the bottom electrode 11 so that the cavity C forms a closed structure. In one embodiment of the present disclosure, the passivation layer 14 is continuously disposed on the oscillatory element 12 and the top electrode 13 and in the opening H1 of the oscillatory element 12.

In one embodiment of the present disclosure, as shown in FIG. 1B, the bottom electrode 11 may be a planer electrode disposed on the substrate 100. The top electrode 13 may be a patterned electrode and, for example, the top electrode 13 may comprise a plurality of strip electrodes 131 arranged along, for example, the X direction. Herein, each strip electrode 131 may, for example, extends along the Y direction and electrically connects to each other, but the present disclosure is not limited thereto.

In one embodiment of the present disclosure, as shown in FIG. 1B, each transducer element 1 may further comprise a first pad P1 and a second pad P2, the first pad P1 is electrically connected to the bottom electrode 11, and the second pad P2 is electrically connected to the top electrode 13. In addition, the first pad P1 and the second pad P2 may be electrically connected to an external signal source (not shown in the figure) respectively. By controlling the voltage of the top electrode 13 and the bottom electrode 11 through the external signal source, it can cause the oscillatory element 12 to vibrate in the cavity C, thereby emitting ultrasonic waves. Therefore, in one embodiment of the present disclosure, the transducer may be an ultrasonic transducer.

In one embodiment of the present disclosure, a suitable method may be used to form a conductive layer on substrate, and the conductive layer is patterned by lithography to form bottom electrode 11. Next, a suitable method may be used to form a sacrificial layer (not shown in the figure) on the bottom electrode 11; and a suitable method is used to form an oscillatory element 12 on the sacrificial layer (not shown in the figure), wherein the oscillatory element 12 has an opening H1. Next, a suitable method is used to form another conductive layer on the oscillatory element 12, and the conductive layer is patterned through a lithography process to form the top electrode 13. Then, the sacrificial layer (not shown in the figure) is removed to form a cavity C between the bottom electrode 11 and the oscillatory element 12. Then, a suitable method is used to form a passivation layer 14 on the oscillatory element 12 and the top electrode 13 and in the opening H1. Next, a suitable method is used to form another conductive layer on the passivation layer 14, and the conductive layer is patterned through lithography to form a first pad P1 and a second pad P2, thereby forming the transducer element 1 shown in FIG. 1C. Herein, the suitable method may comprise electroplating, chemical plating, chemical vapor deposition, physical vapor deposition, sputtering, coating or a combination thereof, but the present disclosure is not limited thereto. The “coating” may be, for example dip coating, spin coating, roller coating, blade coating, spray coating or a combination thereof, but the present disclosure is not limited thereto. In the present disclosure, the method for forming the opening Hl of the oscillatory element 12 may be, for example, mechanical drilling, laser drilling, lithography or a combination thereof, but the present disclosure is not limited thereto. In the present disclosure, the method for removing the sacrificial layer may be, for example, wet etching or dry etching, but the present disclosure is not limited thereto. Through the above process, the effect of simplifying the manufacturing method of the transducer can be achieved in the present disclosure.

In the present disclosure, the material of the substrate 100 may be glass, quartz, sapphire, ceramic, plastic, polycarbonate (PC), polyimide (PI), polypropylene (PP), polyethylene terephthalate (PET), polymethylmethacrylate (PMMA), other suitable material or a combination thereof, but the present disclosure is not limited thereto. In the present disclosure, the same or different materials may be used to prepare the top electrode 13 and the bottom electrode 11, the materials of the top electrode 13 and the bottom electrode 11 may respectively comprise gold, silver, copper, aluminum, titanium, chromium, nickel, molybdenum, tungsten, indium tin oxide (ITO), indium zinc oxide (IZO), indium tin zinc oxide (ITZO), indium gallium zinc oxide (IGZO) or a combination thereof, but the present disclosure is not limited thereto. In the present disclosure, the material of the sacrificial layer may comprise an organic material or an inorganic material, and suitable material may be, for example molybdenum, aluminum, copper, amorphous silicon or polyimide (PI), but the present disclosure is not limited thereto. When the metal material is used as the sacrificial layer, for example, a wet etching process may be used to remove the sacrificial layer; when the non-metal material is used as the sacrificial layer, for example, a dry etching process may be used to remove the sacrificial layer; but the present disclosure is not limited thereto. In the present disclosure, the thickness of the sacrificial layer (equivalent to the thickness T1 of the cavity C) may be 0.1 μm to 10 μm (0.1 μm≤T1≤10 μm), for example 0.1 μm to 5 μm, 0.2 μm to 3 μm, 0.2 μm to 1 μm or 0.5 μm to 1 μm, but the present disclosure is not limited thereto. Herein, the “thickness of the cavity” may refer to, for example, a distance from a bottom surface of the oscillatory element 12 to an upper surface of the bottom electrode 11.

In the present disclosure, the material of the oscillatory element 12 may comprise amorphous silicon, silicon nitride, silicon oxide, silicon oxynitride or an organic compound (for example polyimide (PI), acrylic), but the present disclosure is not limited thereto. In addition, the oscillatory element 12 may be a thin film formed by a single layer of material or multiple layers of materials. In the present disclosure, the thickness T2 of the oscillatory element 12 may be 0.1 μm to 3 μm (0.1 μm≤T2≤3 μm), for example, 0.1 μm to 2 μm, 0.1 μm to 1 μm, 0.2 μm to 0.5 μm or 0.5 μm to 2 μm, but the present disclosure is not limited thereto. Herein, the “thickness of the oscillatory element” may refer to, for example, the distance between the upper surface of the oscillatory element 12 to the bottom surface of the oscillatory element 12. In the present disclosure, the material of the passivation layer 14 may comprise silicon nitride, silicon oxide, silicon oxynitride or a combination thereof, but the present disclosure is not limited thereto. In the present disclosure, the thickness T3 of the passivation layer 14 may be 0.1 μm to 3 μm (0.1 μm≤T3≤3 μm), for example, 0.1 μm to 2 μm, 0.1 μm to 1 μm or 0.2 μm to 1 μm. Herein, the “thickness of the passivation layer” may refer to, for example, the distance from the upper surface of the passivation layer 14 to the upper surface of the top electrode 13; or the distance between the upper surface of the passivation layer 14 and the upper surface of the oscillatory element 12. In the present disclosure, the same or different materials may be used to prepare the first pad P1 and the second pad P2, and the materials of the first pad P1 and the second pad P2 may respectively comprise gold, silver, copper, aluminum, titanium, chromium, nickel, molybdenum, tungsten, indium tin oxide (ITO), indium zinc oxide (IZO), indium tin zinc oxide (ITZO), indium gallium zinc oxide (IGZO) or a combination thereof, but the present disclosure is not limited thereto.

FIG. 2 is a cross-sectional schematic view of a transducer element according to one embodiment of the present disclosure. The transducer element shown in FIG. 2 is similar to that shown in FIG. 1C, except for the following differences.

In one embodiment of the present disclosure, after the step of forming the passivation layer 14 on the oscillatory element 12 and the top electrode 13, a step of patterning the passivation layer 14 may further be included to form the transducer element 1 shown in FIG. 2. More specifically, as shown in FIG. 2, the passivation layer 14 may comprise a first portion 14A and a second portion 14B separated from each other, wherein in the top view direction Z of the transducer element 1, the first portion 14A and the top electrode 13 are overlapped and the second portion 14B covers the opening H1. When the thickness of the passivation layer 14 is too large, the vibration effect of the oscillatory element 12 may be affected. When the passivation layer 14 is designed to have the first portion 14A and the second portion 14B separated from each other, the vibration effect of the oscillatory element 12 may be improved.

In one embodiment of the present disclosure, the first portion 14A of the passivation layer 14 may cover the top electrode 13 to improve the reliability of the transducer element 1. In one embodiment of the present disclosure, the projection of the first portion 14A of the passivation layer 14 on the substrate 100 may be greater than the projection of the top electrode 13 on the substrate 100. In one embodiment of the present disclosure, the second portion 14B of the passivation layer 14 may fill the opening H1 of the oscillatory element 12 and extend from the opening H1 to the cavity C, so the cavity C forms a closed structure. In one embodiment of the present disclosure, to achieve the purpose of patterning the passivation layer 14, the materials of the oscillatory element 12 and the passivation layer 14 are different. For example, the material of the oscillatory element 12 may comprise amorphous silicon, and the material of the passivation layer 14 may include silicon nitride; but the present disclosure is not limited thereto.

In the present disclosure, other details of the transducer element 1 can be as mentioned above and are not described again here. In addition, the materials and the manufacturing processes of the substrate 100, the bottom electrode 11, the oscillatory element 12, the top electrode 13, the passivation layer 14, the first pad P1 and the second pad P2 can also be referred to those described above and are not described again here.

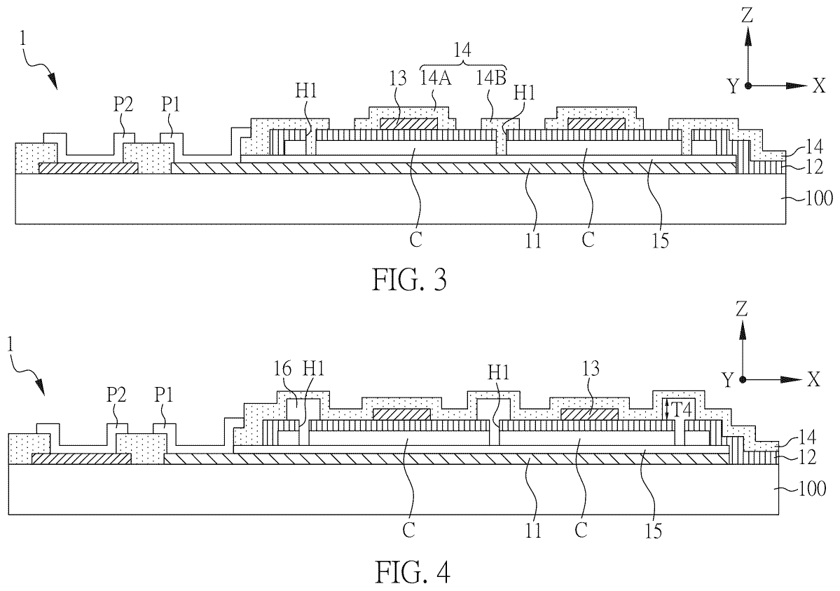

FIG. 3 is a cross-sectional schematic view of a transducer element according to one embodiment of the present disclosure. The transducer element shown in FIG. 3 is similar to that shown in FIG. 2, except for the following differences.

In one embodiment of the present disclosure, after the step of forming the bottom electrode 11 and/or before the step of forming the sacrificial layer on the bottom electrode 11, a step of forming an insulating layer 15 on the bottom electrode 11 by a suitable method may further be included to form the transducer element 1 shown in FIG. 3. More specifically, as shown in FIG. 3, the transducer element 1 may further comprise an insulating layer 15 disposed between the top electrode 13 and the bottom electrode 11. When the material of the oscillatory element 12 comprises amorphous silicon and the oscillatory element 12 comes into contact with the bottom electrode 11 due to vibration, a short circuit between the top electrode 13 and the bottom electrode 11 may be occurred. The above short circuit situation can be avoided through the insulating layer 15 disposed between the top electrode 13 and the bottom electrode 11.

In one embodiment of the present disclosure, as shown in FIG. 3, the insulating layer 15 may be disposed between the bottom electrode 11 and the oscillatory element 12. In one embodiment of the present disclosure, even not shown in the figure, the insulating layer 15 may also be disposed between the top electrode 13 and the oscillatory element 12. In one embodiment of the present disclosure, the passivation layer 14 may continuously extend from the position on the oscillatory element 12 to the position on the insulating layer 15 through the opening H1 and the cavity C. More specifically, the passivation layer 14 may cover the oscillatory element 12 and the top electrode 13 to improve the reliability of the transducer element 1. In addition, the opening H1 of the oscillatory element 12 may be connected to the cavity C, the passivation layer 14 may fill the opening H1 of the oscillatory element 12 and extend from the opening H1 to the cavity C, and a part of the passivation layer 14 (for example, the passivation layer 14 disposed in the opening H1) may be in contact with the insulating layer 15, so that the cavity C forms a closed structure.

In the present disclosure, other details of the transducer element 1 may be as described above and are not described again here. In addition, the materials and the manufacturing processes of the substrate 100, the bottom electrode 11, the oscillatory element 12, the top electrode 13, the passivation layer 14, the first pad P1 and the second pad P2 may be referred to those mentioned above and are not described again here. In the present disclosure, the method for forming the insulating layer 15 may comprise chemical vapor deposition, physical vapor deposition, sputtering, coating or a combination thereof, but the present disclosure is not limited thereto. The “coating” may be, for example, dip coating, spin coating, roller coating, blade coating, spray coating or a combination thereof, but the present disclosure is not limited thereto. In the present disclosure, the material of the insulating layer 15 may comprise silicon nitride, silicon oxide, silicon oxynitride or a combination thereof, but the present disclosure is not limited thereto.

FIG. 4 is a cross-sectional schematic view of a transducer element according to one embodiment of the present disclosure. The transducer element shown in FIG. 4 is similar to that shown in FIG. 1C, except for the following differences.

In one embodiment of the present disclosure, after the step of removing the sacrificial layer, a step of forming a sealing layer 16 on the oscillatory element 12 and covering the opening H1 may further be included. Next, a passivation layer 14 is formed on the sealing layer 16, the oscillatory element 12 and the top electrode 13 to form the transducer element 1 shown in FIG. 4.

In one embodiment of the present disclosure, as shown in FIG. 4, the transducer element 1 may comprise: a bottom electrode 11; an oscillatory element 12 disposed on the bottom electrode 11 and having an opening H1, wherein there is a cavity C between the bottom electrode 11 and the oscillatory element 12; a top electrode 13 disposed on the oscillatory element 12, wherein the top electrode 13 and the bottom electrode 11 are overlapped in the top view direction Z of the transducer element 1; a sealing layer 16 disposed on the oscillatory element 12 and covering the opening H1; and a passivation layer 14 disposed on the sealing layer 16, the oscillatory element 12 and the top electrode 13.

In one embodiment of the present disclosure, after the step of forming the bottom electrode 11 and/or before the step of forming the sacrificial layer on the bottom electrode 11, a step of forming an insulating layer 15 on the bottom electrode 11 by using a suitable method may further be included. Thus, as shown in FIG. 4, the transducer element 1 may further comprise an insulating layer 15 disposed between the top electrode 13 and the bottom electrode 11. More specifically, the insulating layer 15 may be, for example, disposed between the bottom electrode 11 and the oscillatory element 12, so that the problem that the short circuit occurred between the top electrode 13 and the bottom electrode 11 may be prevented. In one embodiment of the present disclosure, even not shown in the figure, the insulating layer 15 may be disposed between the top electrode 13 and the oscillatory element 12.

In one embodiment of the present disclosure, as shown in FIG. 4, the opening H1 of the oscillatory element 12 may be connected to the cavity C, and the sealing layer 16 may fill the opening H1 of the oscillatory element 12 and extend from the opening H1 to the cavity C, so that the cavity C forms a closed structure. In one embodiment of the present disclosure, the sealing layer 16 continuously extends from a position on the oscillatory element 12 to a position on the insulating layer 15 through the opening H1 and the cavity C. In the present disclosure, by disposing the sealing layer 16 to fill the opening H1 of the oscillatory element 12 and maintaining a desired thickness of the passivation layer 14, the impact of the passivation layer 14 on the oscillatory element 12 can be reduced to improve the vibration effect of the oscillatory element 12.

In the present disclosure, other details of the transducer element 1 may be referred to above and are not described again here. In addition, the materials and the manufacturing processes of the substrate 100, the bottom electrode 11, the oscillatory element 12, the top electrode 13, the passivation layer 14, the first pad P1 and the second pad P2 may be referred to above, and are not described here again. In the present disclosure, the method for forming the insulating layer 15 and the sealing layer 16 may respectively comprise chemical vapor deposition, physical vapor deposition, sputtering, coating or a combination thereof, but the present disclosure is not limited thereto. The “coating” may be, for example, dip coating, spin coating, roller coating, blade coating, spray coating or a combination thereof, but the present disclosure is not limited thereto. In the present disclosure, the material of the insulating layer 15 may comprise silicon nitride, silicon oxide, silicon oxynitride or a combination thereof, but the present disclosure is not limited thereto. In the present disclosure, the material of the sealing layer 16 may comprise silicon nitride, silicon oxide, silicon oxynitride, an organic compound or a combination thereof, but the present disclosure is not limited thereto. In the present disclosure, the thickness T4 of the sealing layer 16 may be 0.1 μm to 5 μm (0.1 μm≤T4≤5 μm), for example, 0.1 μm to 3 μm, 0.5 μm to 3 μm, 0.5 μm to 2 μm or 0.5 μm to 1 μm, but the present disclosure is not limited thereto. Herein, the “thickness of the sealing layer” may refer to, for example, the distance from the upper surface of the sealing layer 16 to the upper surface of the oscillatory element 12.

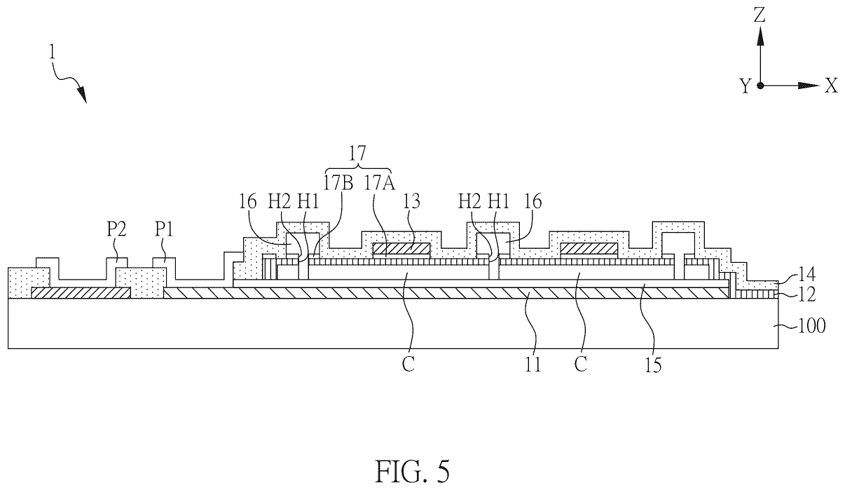

FIG. 5 is a cross-sectional schematic view of a transducer element according to one embodiment of the present disclosure. The transducer element shown in FIG. 5 is similar to that shown in FIG. 4, except for the following differences.

In one embodiment of the present disclosure, after forming the oscillatory element 12, a step of forming another insulating layer 17 on the oscillatory element 12 by a suitable method and patterning the insulating layer 17 through a lithography process may further be included. Next, the steps of forming the top electrode 13 on the insulating layer 17, removing the sacrificial layer, forming the sealing layer 16 on the insulating layer 17 and covering the opening H1, and forming the passivation layer 14 on the sealing layer 16, the oscillatory element 12 and the top electrode 13 are sequentially performed, to form the transducer element 1 shown in FIG. 5.

In one embodiment of the present disclosure, as shown in FIG. 5, the transducer element 1 may further comprise another insulating layer 17, disposed on the oscillatory element 12, wherein the insulating layer 17 comprises a first portion 17A and a second portion 17B. In the top view direction Z of the transducer element 1, the first portion 17A of the insulating layer 17 and the top electrode 13 are overlapped, and the second portion 17B of the insulating layer 17 and the sealing layer 16 are overlapped. In one embodiment of the present disclosure, as shown in FIG. 5, the insulating layer 17 has another opening H2. In the top view direction Z of the transducer element 1, the opening H1 of the oscillatory element 12 and the opening H2 of the insulating layer 17 are overlapped. Thus, the sealing layer 16 may further fill the opening H2 of the insulating layer 17 and the opening H1 of the oscillatory element 12, and extend from the opening H2 and the opening H1 to the cavity C, so that the cavity C forms a closed structure. In the present disclosure, the insulating layer 17 may be used to improve the reliability of the transducer element 1.

In the present disclosure, other details of the transducer element 1 may be referred to above, and are not described again herein. In addition, the materials and the manufacturing processes of the substrate 100, the bottom electrode 11, the oscillatory element 12, the top electrode 13, the passivation layer 14, the insulating layer 15, the first pad P1 and the second pad P2 may be referred to above and are not described again here. In the present disclosure, the method for forming the insulating layer 17 may further comprise chemical vapor deposition, physical vapor deposition, sputtering, coating or a combination thereof, but the present disclosure is not limited thereto. The “coating” may be, for example, dip coating, spin coating, roller coating, blade coating, spray coating or a combination thereof, but the present disclosure is not limited thereto. In the present disclosure, the material of the insulating layer 17 may comprise silicon nitride, silicon oxide, silicon oxynitride or a combination thereof, but the present disclosure is not limited thereto.

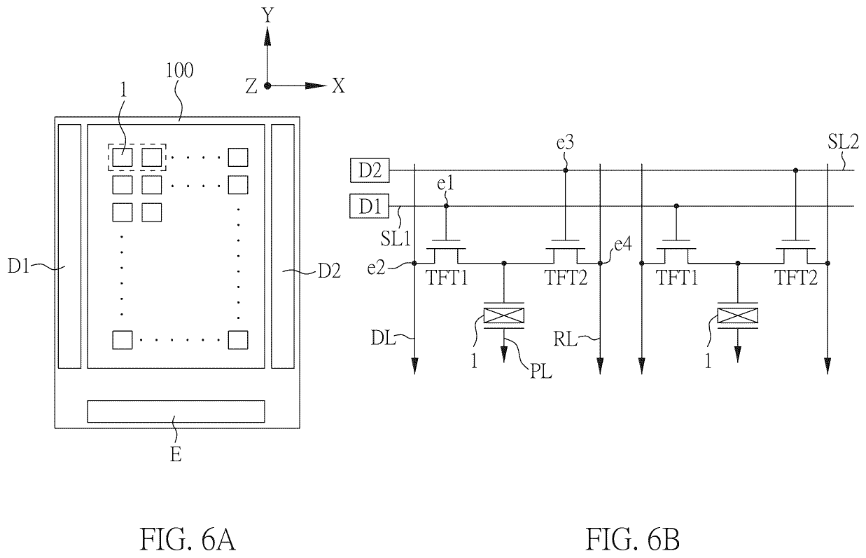

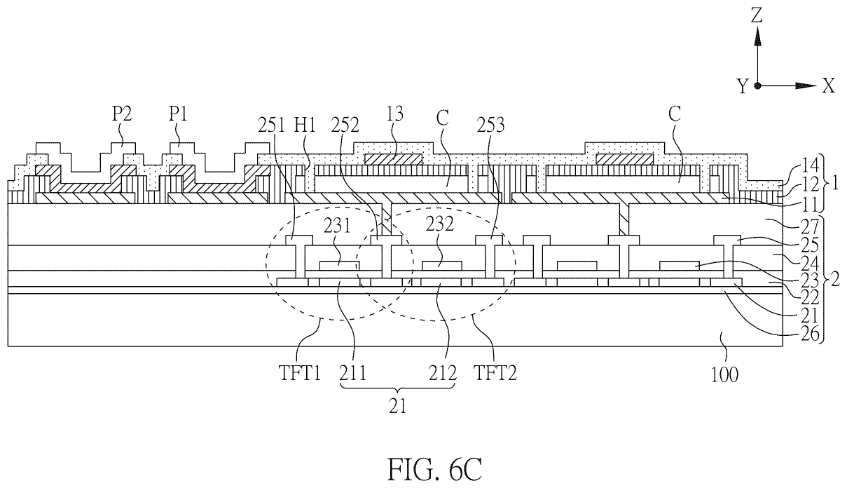

FIG. 6A is a schematic view of a transducer according to one embodiment of the present disclosure. FIG. 6B is a schematic view of an equivalent circuit of the transducer shown in FIG. 6A. FIG. 6C is a cross-sectional schematic view of the transducer shown in FIG. 6A.

In one embodiment of the present disclosure, as shown in FIG. 6A, the plurality of transducer elements 1 may be arranged in array on the substrate 100 to form a two-dimensional (2D) transducer. In the one embodiment of the present disclosure, as shown in FIG. 6A, the transducer may further comprise a first driving circuit D1 and a second driving circuit D2 respectively disposed on the substrate 100, wherein the first driving circuit D1 and the second driving circuit D2 are electrically connected to one of the plurality of transducer elements 1 respectively. In one embodiment of the present disclosure, even one first driving circuit D1 and one second driving circuit D2 are used as an example in FIG. 6A, in other embodiments of the present disclosure, the transducer may comprise a plurality of first driving circuits D1 and/or a plurality of second driving circuits D2 electrically connected to one of the plurality transducer elements 1 respectively.

In one embodiment of the present disclosure, as shown in FIG. 6B and FIG. 6C, the transducer may further comprise a circuit layer 2 disposed between the transducer elements 1 and the substrate 100, wherein the circuit layer 2 may further comprise a first transistor TFT1 and a second transistor TFT2, and the first transistor TFT1 and the second transistor TFT2 are electrically connected to one of the transducer elements 1. More specifically, the circuit layer 2 may comprise a first scan line SL1, a second scan line SL2, a driving line DL and a read line RL, wherein the first scan line SL1 and the driving line DL are electrically connected to the control end e1 and the first end e2 of the first transistor TFT1 respectively, and the second scan line SL2 and the read line RL are electrically connected to the control end e3 and the first end e4 of the second transistor TFT2 respectively.

In one embodiment of the present disclosure, as shown in FIG. 6B and FIG. 6C, the first driving circuit D1 is electrically connected to the first scan line SL1, and the second driving circuit D2 is electrically connected to the second scan line SL2. The first driving circuit D1 may control the first transistor TFT1 through the first scan line SL1 to transmit the signal of the driving line DL to the transducer element 1, so the oscillatory element 12 in the transducer element 1 vibrates to generate ultrasonic waves. The second driving circuit D2 may control the second transistor TFT2 through the second scan line SL2. When the oscillatory element 12 of the transducer element 1 receives ultrasonic waves and vibrates, the vibrating signal can be transmitted to the read line RL to read out and calculate the result.

In one embodiment of the present disclosure, as shown in FIG. 6B and FIG. 6C, the transducer may further comprise a power line PL electrically connected to the transducer element 1. More specifically, the power line PL may provide a DC bias through the first pad P1 and/or the second pad P2 to the top electrode 13 of the transducer element 1. By controlling the voltage of the top electrode 13 and the bottom electrode 11, the oscillatory element 12 may generate vibrations in the cavity C, thereby emitting ultrasonic waves.

In one embodiment of the present disclosure, the transducer element 1 shown in FIG. 6C is, for example, the transducer element 1 shown in FIG. 1C as an example, but the present disclosure is not limited thereto. In other embodiments of the present disclosure, even not shown in the figure, the transducer element 1 shown in FIG. 6C may be replaced by any transducer element 1 shown in FIG. 2 to FIG. 5. The details of the transducer element 1 may be referred to above and are not described again here.

In one embodiment of the present disclosure, as shown in FIG. 6A, the transducer may further comprise an electronic element E disposed on the substrate 100, wherein the electronic element E may be electrically connected to the first driving circuit D1 and the second driving circuit D2 respectively. The electronic element E may be, for example, used to control or receive the signals transmitting to the first driving circuit D1 and/or the second driving circuit D2. In one embodiment of the present disclosure, the electronic element E may be integrated circuit (IC), but the present disclosure is not limited thereto.

In one embodiment of the present disclosure, as shown in FIG. 6C, the circuit layer 2 may comprise: an active layer 21 disposed on the substrate 100 and comprising a first active unit 211 and a second active unit 212; a gate insulating layer 22 disposed on the active layer 21; a gate electrode layer 23 disposed on the gate insulating layer 22 and comprising a first gate electrode 231 and a second gate electrode 232; an insulating layer 24 disposed on the gate electrode layer 23; an electrode layer 25 disposed on the insulating layer 24 and comprising a first electrode 251, a second electrode 252 and a third electrode 253, wherein the first electrode 251 and the second electrode 252 may be electrically connected to the first active unit 211 respectively, and the second electrode 252 and the third electrode 253 may be electrically connected to the second active unit 212 respectively. The first active unit 211, the gate insulating layer 22, the first gate electrode 231, the insulating layer 24, the first electrode 251 and the second electrode 252 may form the first transistor TFT1. The second active unit 212, the gate insulating layer 22, the second gate electrode 232, the insulating layer 24, the second electrode 252 and the third electrode 253 may form the second transistor TFT2. In addition, the second electrode 252 may be electrically connected to one of the plurality of transducer elements 1, thereby transmitting the signal of the first transistor TFT1 to the transducer element 1, or receiving the signal transmitted from the transducer element 1 to the second transistor TFT2, but the present disclosure is not limited thereto. It should be noted that, the structures of the first transistor TFT1 and the second transistor TFT2 are used as an example, and can be adjusted to other laminated structures (for example, a double gate or top gate transistor) according to the needs.

In the present disclosure, the material of the active layer 21 may comprise amorphous silicon, polycrystalline silicon (for example, low-temperature polycrystalline silicon (LTPS)), or oxide semiconductor (for example, indium gallium zinc oxide (IGZO) or indium gallium oxide (IGO)), but the present disclosure is not limited thereto. In the present disclosure, the materials of the gate insulating layer 22 and the insulating layer 24 may respectively comprise silicon nitride, silicon oxide, silicon oxynitride, silicon carbonitride or a combination thereof, but the present disclosure is not limited thereto. In the present disclosure, the materials of the gate electrode layer 23 and the electrode layer 25 may respectively comprise a metal, a metal oxide, an alloy thereof or a combination thereof and may be, for example, gold, silver, copper, palladium, platinum, ruthenium, aluminum, cobalt, nickel, titanium, molybdenum, manganese, indium zinc oxide (IZO), indium tin oxide (ITO), indium tin zinc oxide (ITZO), indium gallium zinc oxide (IGZO), or aluminum zinc oxide (AZO), but the present disclosure is not limited thereto.

In one embodiment of the present disclosure, as shown in FIG. 6C, the circuit layer 2 may comprise a buffer layer 26 disposed between the substrate 100 and the active layer 21. In one embodiment of the present disclosure, as shown in FIG. 6C, the circuit layer 2 may comprise a planer layer 27 disposed between the electrode layer 25 and the bottom electrode 11. In the present disclosure, the materials of the buffer layer 26 and the planer layer 27 may respectively comprise silicon nitride, silicon oxide, silicon oxynitride, silicon carbonitride or a combination thereof, but the present disclosure is not limited thereto.

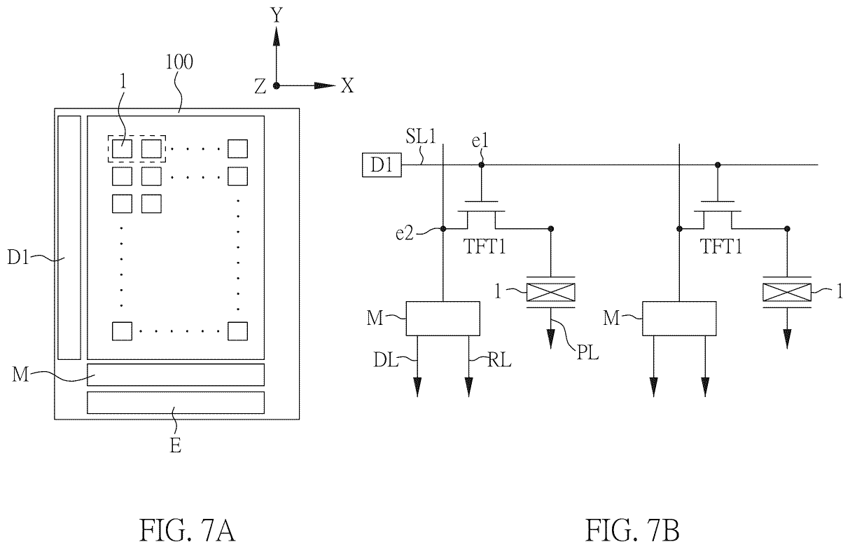

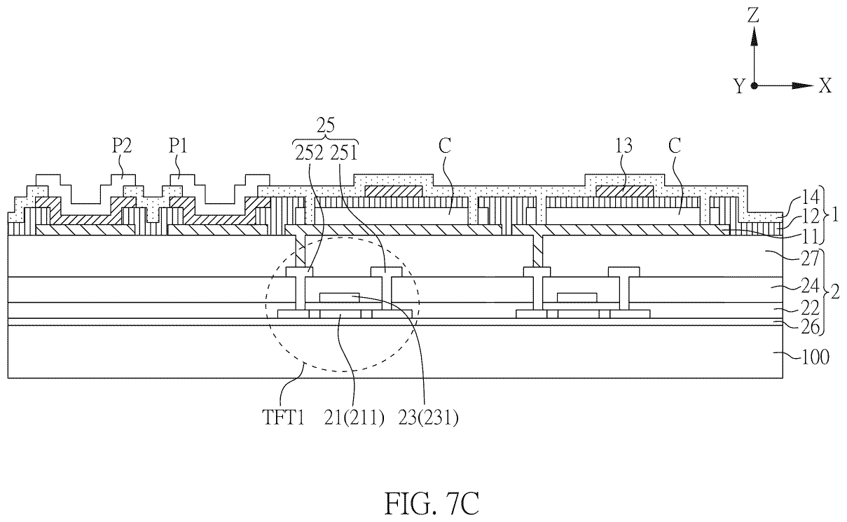

FIG. 7A is a schematic view of a transducer according to one embodiment of the present disclosure. FIG. 7B is a schematic view of an equivalent circuit of the transducer shown in FIG. 7A. FIG. 7C is a cross-sectional schematic view of the transducer shown in FIG. 7A.

In one embodiment of the present disclosure, as shown in FIG. 7A, the plurality of transducer elements 1 may be arranged in array on the substrate 100 to form a two-dimensional (2D) transducer. In one embodiment of the present disclosure, as shown in FIG. 7A, the transducer may further comprise a first driving circuit DI and a multiplexer M (MUX) respectively disposed on the substrate 100, wherein the first driving circuit D1 and the multiplexer M are electrically connected to one of the plurality of transducer elements 1 respectively. Although one first driving circuit D1 and one multiplexer M are shown in FIG. 7A as an example, in other embodiments of the present disclosure, the transducer may comprise a plurality of first driving circuits D1 and/or a plurality of multiplexers M electrically connected to one of the plurality of transducer elements 1 respectively.

In one embodiment of the present disclosure, as shown in FIG. 7B and FIG. 7C, the transducer may further comprise a circuit layer 2 disposed between the plurality of transducer elements 1 and the substrate 100, wherein the circuit layer 2 may comprise a first transistor TFT1 electrically connected to one of the transducer elements 1 and the multiplexer M. More specifically, the circuit layer 2 may comprise a first scan line SL1, a driving line DL and a read line RL, wherein the first scan line SL1 and the multiplexer M are electrically connected to the control end e1 and the first end e2 of the first transistor TFT1 respectively, and the driving line DL and the read line RL are electrically connected to the multiplexer M respectively. The first driving circuit D1 may control the first transistor TFT1 through the first scan line SL1, and the multiplexer M may control or switch the driving line DL or the read line RL to transmit or receive signals.

In one embodiment of the present disclosure, as shown in FIG. 7B and FIG. 7C, the transducer may further comprise a power line PL electrically connected to the transducer element 1. More specifically, the power line PL may provide a DC bias through the first pad P1 and/or the second pad P2 to the top electrode 13 of the transducer element 1. By controlling the voltage of the top electrode 13 and the bottom electrode 11, the oscillatory element 12 may generate vibration in the cavity C, thereby emitting ultrasonic waves.

In one embodiment of the present disclosure, the transducer element 1 shown in FIG. 7C is, for example, the transducer element 1 shown in FIG. 1C as an example, but the present disclosure is not limited thereto. In other embodiments of the present disclosure, even not shown in the figure, the transducer element 1 of FIG. 7C may be replaced by any of the transducer element 1 shown in FIG. 2 to FIG. 5. The details of the above transducer element 1 may be referred to above and are not described here again.

In one embodiment of the present disclosure, as shown in FIG. 7A, the transducer may further comprise an electronic element E disposed on the substrate 100, wherein the electronic element E may be electrically connected to the first driving circuit D1 and the multiplexer M respectively. The electronic element E may be, for example, used to control or receive the signals transmitted to the first driving circuit D1 and/or the multiplexer M. In one embodiment of the present disclosure, the electronic element E may be an integrated circuit (IC), but the present disclosure is not limited thereto.

In one embodiment of the present disclosure, as shown in FIG. 7C, the circuit layer 2 may comprise: an active layer 21 disposed on the substrate 100 and comprising a first active unit 211; a gate insulating layer 22 disposed on the active layer 21; a gate electrode layer 23 disposed on the gate insulating layer 22 and comprising a first gate electrode 231; an insulating layer 24 disposed on the gate electrode layer 23; an electrode layer 25 disposed on the insulating layer 24 and comprising a first electrode 251 and a second electrode 252, wherein the first electrode 251 and the second electrode 252 may be electrically connected to the first active unit 211 respectively. The first active unit 211, the gate insulating layer 22, the first gate electrode 231, the insulating layer 24, the first electrode 251 and the second electrode 252 may form the first transistor TFT1. In addition, the second electrode 252 may be electrically connected to one of the transducer elements 1, thereby transmitting the signals of the first transistor TFT1 to the transducer element 1, or receiving the signals emitting from the transducer element 1 to the first transistor TFT1, but the present disclosure is not limited thereto. It should be noted that, the structure of the first transistor TFT1 shown in the figure is used as an example, and may be adjusted to other laminated structure (for example, a double gate or top gate transistor) according to the needs.

In the present disclosure, the material of the active layer 21 may comprise amorphous silicon, polycrystalline silicon (for example, low-temperature polycrystalline silicon (LTPS)), or oxide semiconductor (for example, indium gallium zinc oxide (IGZO) or indium gallium oxide (IGO)), but the present disclosure is not limited thereto. In the present disclosure, the materials of the gate insulating layer 22 and the insulating layer 24 may respectively comprise silicon nitride, silicon oxide, silicon oxynitride, silicon carbonitride or a combination thereof, but the present disclosure is not limited thereto. In the present disclosure, the materials of the gate electrode layer 23 and the electrode layer 25 may respectively comprise a metal, an metal oxide, an alloy thereof or a combination thereof, and may be, for example, gold, silver, copper, palladium, platinum, ruthenium, aluminum, cobalt, nickel, titanium, molybdenum, manganese, indium zinc oxide (IZO), indium tin oxide (ITO), indium tin zinc oxide (ITZO), indium gallium zinc oxide (IGZO), or aluminum zinc oxide (AZO), but the present disclosure is not limited thereto.

In one embodiment of the present disclosure, as shown in FIG. 7C, the circuit layer 2 may comprise a buffer layer 26 disposed between the substrate 100 and the active layer 21. In one embodiment of the present disclosure, as shown in FIG. 7C, the circuit layer 2 may comprise a planer layer 27 disposed between the electrode layer 25 and the bottom electrode 11. In the present disclosure, the materials of the buffer layer 26 and the planer layer 27 may respectively comprise silicon nitride, silicon oxide, silicon oxynitride, silicon carbonitride or a combination thereof, but the present disclosure is not limited thereto.

The above specific embodiments should be construed as illustrative only and not in any way limiting the remainder of the disclosure.

Although the present disclosure has been explained in relation to its embodiment, it is to be understood that many other possible modifications and variations can be made without departing from the spirit and scope of the disclosure as hereinafter claimed.

1. A transducer, comprising:
a substrate; and
a plurality of transducer elements disposed on the substrate, wherein each of the plurality of transducer elements comprises:
a bottom electrode;
an oscillatory element disposed on the bottom electrode and having an opening, wherein there is a cavity between the bottom electrode and the oscillatory element;
a top electrode disposed on the oscillatory element, wherein the top electrode and the bottom electrode are overlapped in a top view direction; and
a passivation layer disposed on the oscillatory element and the top electrode and in the opening of the oscillatory element, wherein the passivation layer continuously extends from a position on the oscillatory element to a position on the bottom electrode through the opening and the cavity.

2. The transducer of claim 1, wherein the passivation layer continuously disposed on the oscillatory element and the top electrode and in the opening.

3. The transducer of claim 1, wherein a material of the oscillatory element is different from a material of the passivation layer.

4. The transducer of claim 1, wherein the passivation layer comprises a first portion and a second portion separated from each other, wherein in the top view direction, the first portion and the top electrode are overlapped and the second portion covers the opening.

5. The transducer of claim 1, wherein a material of the oscillatory element comprise amorphous silicon, silicon nitride, silicon oxide, silicon oxynitride or an organic compound.

6. The transducer of claim 1, wherein each of the plurality of transducer elements further comprises an insulating layer disposed between the top electrode and the bottom electrode.

7. The transducer of claim 1, wherein the plurality of transducer elements are arranged on the substrate along a direction.

8. The transducer of claim 1, wherein the plurality of transducer elements are arranged in array on the substrate.

9. The transducer of claim 1, further comprising a circuit layer disposed between the plurality of transducer elements and the substrate, wherein the circuit layer comprises a first transistor and a second transistor, and the first transistor and the second transistor are electrically connected to one of the plurality of transducer elements.

10. The transducer of claim 9, wherein the circuit layer comprises a first scan line, a second scan line, a driving line and a read line, wherein the first scan line and the driving line are electrically connected to a control end and a first end of the first transistor respectively, and the second scan line and the read line are electrically connected to a control end and a first end of the second transistor respectively.

11. The transducer of claim 10, further comprising a first driving circuit and a second driving circuit, wherein the first driving circuit is electrically connected to the first scan line, and the second driving circuit is electrically connected to the second scan line.

12. The transducer of claim 1, further comprising a circuit layer and a multiplexer, wherein the circuit layer is disposed between the plurality of transducer elements and the substrate, and the multiplexer is disposed on the substrate, wherein the circuit layer comprises a first transistor, and the multiplexer is electrically connected to the first transistor.

13. A transducer, comprising:
a substrate; and
a plurality of transducer elements disposed on the substrate, wherein each of the plurality of transducer elements comprises:
a bottom electrode;
an oscillatory element disposed on the bottom electrode and having an opening, wherein there is a cavity between the bottom electrode and the oscillatory element;
a top electrode disposed on the oscillatory element, wherein the top electrode and the bottom electrode are overlapped in a top view direction;
a sealing layer disposed on the oscillatory element and covering the opening; and
a passivation layer disposed on the sealing layer, the oscillatory element and the top electrode.

14. The transducer of claim 13, wherein a material of the oscillatory element is different from a material of the passivation layer.

15. The transducer of claim 13, wherein each of the plurality of transducer elements further comprises an insulating layer disposed between the top electrode and the bottom electrode.

16. The transducer of claim 13, wherein the plurality of transducer elements are arranged on the substrate along a direction.

17. The transducer of claim 13, wherein the plurality of transducer elements are arranged in array on the substrate.

18. The transducer of claim 13, further comprising a circuit layer disposed between the plurality of transducer elements and the substrate, wherein the circuit layer comprises a first transistor and a second transistor, and the first transistor and the second transistor are electrically connected to one of the plurality of transducer elements.

19. The transducer of claim 18, wherein the circuit layer comprises a first scan line, a second scan line, a driving line and a read line, wherein the first scan line and the driving line are electrically connected to a control end and a first end of the first transistor respectively, and the second scan line and the read line are electrically connected to a control end and a first end of the second transistor respectively.

20. The transducer of claim 20, further comprising a first driving circuit and a second driving circuit, wherein the first driving circuit is electrically connected to the first scan line, and the second driving circuit is electrically connected to the second scan line.
